(19) United States
(12) Patent Application Publication
(10) Pub. No.: US 2005/0184098 A1
(43) Pub. Date: Aug. 25, 2005

(54) Water shield

(76) Inventor: Mark H. Dixon, Dorchester, MA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/061,017

(22) Filed: Feb. 18, 2005

Related U.S. Application Data
(60) Provisional application No. 60/546,154, filed on Feb. 20, 2004.

(51) Int. Cl. B67D 1/00

(52) U.S. Cl. 222/192; 222/78; 222/79; 273/349

(57) ABSTRACT

A water shield includes a shield blank including a front surface and a back surface. Disposed on the front surface is one or more nozzle, and disposed on the back surface are a handle and a trigger. The operator of the water shield grabs the handle to maneuver the water shield in position to block any incoming streams of water from ordinary water guns. In return, the operator activates the trigger to eject a stream of water from the nozzle.

### CROSS-REFERENCE TO RELATED APPLICATIONS

This application claims the benefit of U.S. Provisional Patent Application No. 60/546,154 filed Feb. 20, 2004 and entitled “Water Shield”, which is incorporated by reference herein in its entirety.

### BACKGROUND OF THE INVENTION

1. Field of the Invention

This invention is related to toys for spraying or squirting water.

2. Description of the Related Art

Water guns have been popular toys for decades. Prior to the 1980's, water guns were manufactured in many different shapes and sizes. For example, some water guns were shaped as pistols (although usually made from transparent plastic), space-age “ray” guns, animals, or even cartoon characters. While the shapes and colors of the guns were quite diverse, the guns all had a very similar means of squirting water. Typically, such squirt guns used a small, spring loaded, positive displacement pumping system to force water from a reservoir in the gun through a nozzle. The pumping system on such water guns is actuated by the pressure exerted by one finger of an operator upon a trigger of the gun. As a result, such systems are usually only good for squirting water up to ranges of about 10 feet, and the amount of water squirted by such guns was only sufficient to leave a small line of water on your friend's shirt.

In the 1980's the operation of water guns became more advanced, with some water guns using battery driven motors to provide squirting ranges of up to 30 feet. Water guns designed with small electric pumps are shown in U.S. Pat. Nos. 4,706,848 and 4,743,030.

One of the biggest advances in water gun technology was the compressed air water gun, which was invented by a nuclear engineer named Lonnie Johnson and is described in U.S. Pat. No. 4,591,071, entitled “Squirt Gun”, which is incorporated by reference herein in its entirety. The compressed air water gun was originally sold to the public in 1989 under the brand name “Power Drencher”, which was eventually renamed Super Soaker®. This invention revolutionalized water guns by using compressed air to shoot a powerful blast of water for distances of up to 50 feet. Unlike water guns of the past, which squirted only enough water to leave a small line of water on your friend's shirt, squirting your friend with a Super Soaker® would result in your friend having to go home and change his clothes. The water gun “arms race” has since escalated, with such advances as back-pack water reservoirs and multiple stream nozzles. Advances in the early compressed air water gun have been described, for example, in U.S. Pat. No. 5,150,819, entitled “Double Tank Pinch Trigger Pump Water Gun”, and 6,540,108, entitled “Toy Water Gun”, both of which are incorporated by reference herein in their entirety.

Therefore, the present inventor has determined a need for a device that would offer the advances of modern water guns, while providing protection from such modern water guns.

### BRIEF SUMMARY OF THE INVENTION

The above needs are met by a water shield. The water shield comprises: a shield blank including a front surface and a back surface; at least one nozzle disposed on the front surface; a handle disposed on the back surface; and a trigger disposed proximate at least one of the handle and the back surface. A pressurized stream of water is ejected from the nozzle in response to activation of the trigger by an operator. The front surface is configured to block the operator from one or more incoming water streams.

The shield blank may include a reservoir disposed therein for containing water to be ejected from the nozzle, and the reservoir may be pressurized by air. A pump disposed on the back surface of the shield blank may pressurize the air. The shield blank may further include lightening voids disposed therein. The shield blank may include at least one window disposed therein for indicating a water level in the reservoir, and may include arm straps disposed on the back surface of the shield blank. Preferably, the shield blank has a width of between about 10 inches to about 36 inches, and a length of between about 10 inches to about 36 inches. The front surface of the shield blank may be convex. A window may be disposed through the shield blank to allow the operator to view a target for the stream of water while being shielded from the one or more incoming streams.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

The invention will be more fully understood from the following detailed description taken in conjunction with the accompanying drawings wherein like elements are numbered alike, and in which:

FIG. 1 is a front view of a water shield;

FIG. 2 is a back view of the water shield; and

FIG. 3 is a side view of the water shield.

### DETAILED DESCRIPTION

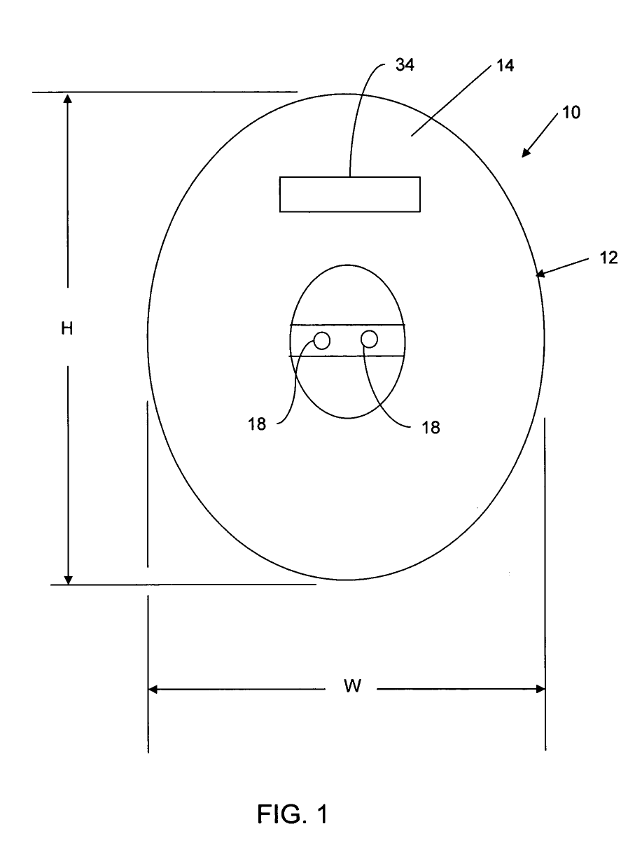

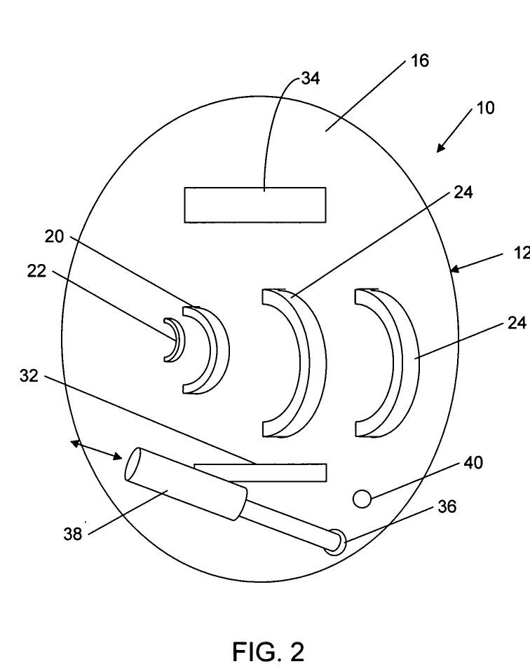

Referring to FIGS. 1-3, a water shield, shown generally at 10, includes a shield blank 12 including a front surface 14 and a back surface 16. Disposed on the front surface 14 is one or more nozzle 18, and disposed on the back surface 16 are a handle 20 and a trigger 22. The operator of the water shield 10 grabs the handle 20 to maneuver the water shield 10 in position to block any incoming streams of water from ordinary water guns. In return, the operator activates the trigger 22 to eject a stream of water from the one or more nozzle 18.

The shield blank 12 is preferably formed from a lightweight, rigid material such as, for example, molded plastic. The shield blank 12 may be shaped such that the front and back surfaces 14 and 16 are flat, or the front and back surfaces 14 and 16 may be shaped to aid in the deflection of incoming water streams. Preferably, the front surface 14 is convex. In addition to the handle 20, arm straps 24 may be added to the back surface 16 of the shield 10 for receiving an arm of the operator. Such arm straps 24 help the operator support and maneuver the shield 10. The shield blank 12 may be of any convenient shape, and the size of the shield blank 12 is selected based on the size of the intended user. Preferably, the shield blank 12 has a width “w” of between about 10 inches to about 36 inches, and a height “h” of between about 10 inches to about 36 inches.

In the embodiment shown, a water reservoir 26 is contained in the shield blank 12. The water reservoir 26 may be defined by the entire internal portion of the shield blank 12, or the shield blank 12 may be divided into sections by walls 28. The walls 28 define lightening voids 30, which will lighten the weight of the water shield 10 by limiting the size of the water reservoir 26. It is also contemplated that the water reservoir 26 may be in the form of a tank separated from the shield blank 12 and connected to the nozzle 18 by flexible tubing or the like. Such an external tank may be worn on the back of the operator of shield 10. With this arrangement, the external tank may be pressurized by a pump, and the fluid in the tank delivered to the nozzle 18 via the flexible tubing.

The shield blank 12 may include at least one window 32 disposed therein for indicating a water level in the reservoir 26. Also, the shield blank 12 may include one or more windows 34 disposed therein for allowing the operator of the shield 10 to view a target for the stream of water ejected by the nozzle 18 while being shielded from the one or more incoming streams.

The reservoir 26 may be pressurized by air, which is received through a hole 36 in the back surface 16 of the shield blank 12. The pressurized air may be delivered by a pump 38 mounted to the back surface 16. Alternatively, the hole 36 may be fitted with an air valve (e.g., a Schraeder valve such as those found on bicycle tires and the like) which receive a removable pump for pressurizing air in the reservoir. A water hole 40 and removable plug disposed in the back surface 16 of the shield blank 12 allow water to be added to the reservoir 26.

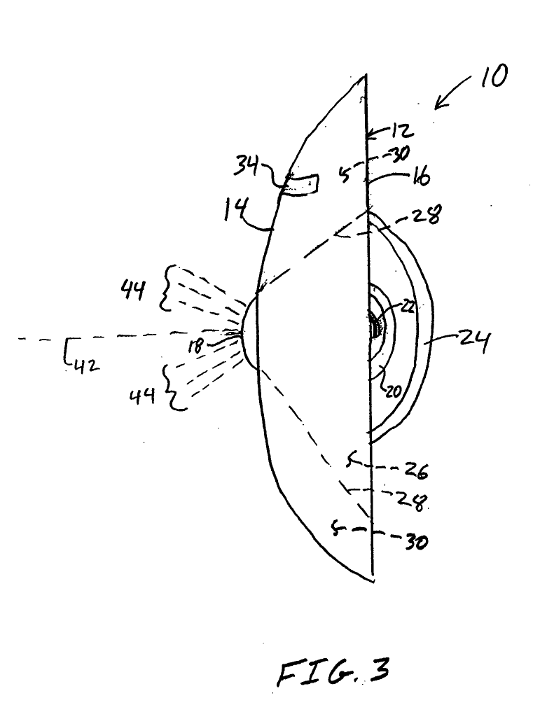

The one or more nozzles 18 may provide single or multiple water streams in various patterns. For example, one nozzle 18 may provide a single, solid stream of water, as shown at 42 in FIG. 3 while another nozzle 18 provides a number of smaller streams as shown at 44 in FIG. 3.

The system for delivering water from the reservoir 26 to the nozzle 18 in response to activation of the trigger 22 may be any system known in the art. For example, the nozzle 18, trigger 22, and reservoir 26 may be arranged in a manner as described in U.S. Pat. No. 5,150,819, entitled “Double Tank Pinch Trigger Pump Water Gun”, or U.S. Pat. No. 6,540,108, entitled “Toy Water Gun”, both of which are incorporated by reference herein in their entirety.

The water shield 10 offers the advances of modern compressed air water guns, while offering the operator protection from one or more incoming streams of water.

A number of embodiments of the present invention have been described. Nevertheless, it will be understood that various modifications may be made without departing from the spirit and scope of the invention. Accordingly, other embodiments are within the scope of the following claims.

1. A water shield comprises:
a shield blank including a front surface and a back surface;
at least one nozzle disposed on the front surface;
a handle disposed on the back surface; and
a trigger disposed proximate at least one of the handle and the back surface, wherein a pressurized stream of water is ejected from the nozzle in response to activation of the trigger by an operator, and the front surface is configured to block the operator from one or more incoming water streams.

2. The water shield of claim 1, wherein the shield blank includes a reservoir disposed therein for containing water to be ejected from the nozzle.

3. The water shield of claim 2, wherein the reservoir further contains pressurized air.

4. The water shield of claim 3, wherein the air is pressurized by a pump disposed on the back surface of the shield blank.

5. The water shield of claim 2, wherein the shield blank further includes lightening voids disposed therein, the lightening voids being defined by walls preventing the water from the reservoir from entering the lightening voids.

6. The water shield of claim 2, wherein the shield blank includes at least one window disposed therein for indicating a water level in the reservoir.

7. The water shield of claim 1, further comprising arm straps disposed on the back surface of the shield blank.

8. The water shield of claim 1, wherein the shield blank has a width of between about 10 inches to about 36 inches, and a length of between about 10 inches to about 36 inches.

9. The water shield of claim 1, wherein the front surface of the shield blank is convex.

10. The water shield of claim 1, further comprising:
a window disposed through the shield blank, the window allowing the operator to view a target for the stream of water while being shielded from the one or more incoming streams.

11. The water shield of claim 1, wherein the water ejected from the nozzle is delivered to the nozzle from a reservoir external to the shield blank.

12. A water shield comprises:
a shield blank including a front surface and a back surface, the shield blank has a width of between about 10 inches to about 36 inches, and a length of between about 10 inches to about 36 inches;
at least one nozzle disposed on the front surface;
a handle disposed on the back surface;
a reservoir in fluid communication with the nozzle; and
a trigger disposed proximate at least one of the handle and the back surface, wherein pressurized water from the reservoir is ejected from the nozzle in response to activation of the trigger by an operator, and the front surface is configured to block the operator from one or more incoming water streams.

13. The water shield of claim 12, wherein the reservoir is within the shield blank.

14. The water shield of claim 12, wherein the reservoir is external to the shield blank.

15. The water shield of claim 12, wherein the fluid is pressurized by a pump coupled to the reservoir.

16. The water shield of claim 12, further comprising arm straps disposed on the back surface of the shield blank.

17. The water shield of claim 12, wherein the front surface of the shield blank is convex.

18. The water shield of claim 12, further comprising:
a window disposed through the shield blank, the window allowing the operator to view a target for the stream of water while being shielded from the one or more incoming streams.
